(19) United States
(12) Patent Application Publication
(10) Pub. No.: US 2026/0133903 A1
(43) Pub. Date: May 14, 2026

(54) STORAGE DEVICE AND METHOD FOR OPERATING STORAGE DEVICE

(71) Applicant: SK hynix Inc, Icheon-si (KR)

(72) Inventors: Tae Ha KIM, Icheon-si (KR); Jee Yul KIM, lcheon-si (KR)

(21) Appl. No.: 19/084,267

(22) Filed: Mar. 19, 2025

(30) Foreign Application Priority Data
Nov. 11, 2024 (KR) 10-2024-0158774

(51) Int. Cl. G06F 12/02; G06F 12/0871; G06F 13/16

(52) U.S. Cl. CPC G06F 12/0246; G06F 12/0871; G06F 13/1668; G06F 2212/1021; G06F 2212/507

(57) ABSTRACT

A data storage device may include a memory device and a controller. The memory device may include a compression memory area where data is stored in a compressed state and a non-compression memory area where data is stored in a non-compressed state. The controller may: receive, from a host, a speculative memory read command indicating that there is a possibility that target data corresponding to a target logical address is to be read; search for, in response to receiving the speculative memory read command, where the target data is stored in the memory device, either in the compression memory area or the non-compression memory area; and determine whether to store the target data in a cache configured to store data read from the memory, based on where the target data is stored in the memory device, either in the compression memory area and the non-compression memory area.

### CROSS-REFERENCE TO RELATED APPLICATION

This patent document claims the priority and benefits of Korean Patent Application No. 10-2024-0158774 filed on Nov. 11, 2024, which is incorporated herein by reference in its entirety.

### TECHNICAL FIELD

Various embodiments of the disclosed technology relate to a data storage device and a method for operating the data storage device.

### BACKGROUND

A storage device is used to store data based on requests from external devices, such as computers, mobile devices (e.g., smartphones or tablets), and similar devices.

A storage device may include a memory device for data storage and a controller to manage the memory device. The memory device may be a volatile memory device or a non-volatile memory device. The controller may receive commands from external devices (e.g., a host), and performs operations, such as reading, writing, or erasing data, in the memory device based on the received commands.

To make more efficient use of the memory device, the storage device may compress data before storing it in the memory.

### SUMMARY

The disclosed technology can be implemented in some embodiments to provide a data storage device and its operating method designed to prevent a decrease in cache hit rate and a deterioration in read performance caused by decompressing low-usability data and storing the decompressed data in a cache.

In an aspect, a storage device may include: a memory device including a compression memory area where data is stored in a compressed state and a non-compression memory area where data is stored in a non-compressed state (e.g., data is stored in its original size); and a controller configured to: receive, from a host, a speculative memory read command indicating that there is a possibility that target data corresponding to a target logical address is to be read (e.g., a possibility that target data corresponding to a target logical address is to be read is greater than a reference possibility value); determine, in response to receiving the speculative memory read command, where the target data is stored in the memory device, either in the compression memory area or the non-compression memory area, and determine whether to store the target data in a cache configured to store data read from the memory, based on where the target data is stored in the memory device, either in the compression memory area or the non-compression memory area.

In another aspect, a method for operating a storage device may include: receiving, from a host, a speculative memory read command indicating that there is a possibility that target data corresponding to a target logical address is to be read (e.g., a possibility that target data corresponding to a target logical address is to be read is greater than a reference possibility value); determining where the target data is stored in a memory device including a compression memory area where data is stored in a compressed state and a non-compression memory area where data is stored in a non-compressed state (e.g., data is stored in its original size); and determining whether to store the target data in a cache configured to store data read from the memory, based on where the target data is stored in the memory device, either in the compression memory area or the non-compression memory area.

In another aspect, a compute express link (CXL) device may include: a memory device including a compression memory area where data is stored in a compressed state and a non-compression memory area where data is stored in a non-compressed state (e.g., data is stored in its original size); and a CXL controller configured to: receive, through a CXL interface from a host, a speculative memory read command indicating that there is a possibility that target data corresponding to a target logical address is to be read (e.g., a possibility that target data corresponding to a target logical address is to be read is greater than a reference possibility value); determine, in response to receiving the speculative memory read command, where the target data is stored in the memory device, either in the compression memory area or the non-compression memory area; and determine whether to store the target data in a cache configured to store data read from the memory, based on an area where the target data is stored in the memory device, either in the compression memory area or the non-compression memory area.

In some embodiments of the disclosed technology, a data storage device and its operating method can prevent a decrease in cache hit rate and a deterioration in read performance, caused by decompressing low-usability data and storing the decompressed data in a cache.

### BRIEF DESCRIPTION OF THE DRAWINGS

FIG. 1 is a schematic configuration diagram of a storage device according to an embodiment of the disclosed technology.

FIG. 2 is a block diagram schematically illustrating a memory of FIG. 1.

FIG. 3 is a diagram illustrating the schematic structure of a storage device based on some embodiments of the disclosed technology.

FIG. 4 is a diagram illustrating an operation in which the storage device based on some embodiments of the disclosed technology searches for target data stored in a compression memory area using a compression map table.

FIG. 5 is a flowchart illustrating an operation in which the storage device based on some embodiments of the disclosed technology determines an area where target data is stored.

FIG. 6 is a diagram illustrating an operation in which the storage device based on some embodiments of the disclosed technology stores a compression map entry corresponding to a target logical address in a cache.

FIG. 7 is a diagram illustrating an example of an operation in which the storage device based on some embodiments of the disclosed technology determines whether to store target data in a cache.

FIG. 8 is a diagram illustrating another example of the operation in which the storage device based on some embodiments of the disclosed technology determines whether to store target data in a cache.

FIG. 9 is a flowchart illustrating an operation in which the storage device based on some embodiments of the disclosed technology determines whether to store target data in a cache, depending on the compressed size of the target data.

FIG. 10 is a diagram illustrating a method for operating a storage device based on some embodiments of the disclosed technology.

### DETAILED DESCRIPTION

The methods, processes, and/or operations described herein may be performed by code or instructions executed by a computer, processor, controller, or other signal processing device. The computer, processor, controller, or other signal processing device may include those described herein or one in addition to the elements described herein. Given that the algorithms underlying these methods (or operations of the computer, processor, controller, or other signal processing device) are described in detail, the code or instructions for implementing the operations of these methods may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed by, for example, a computer, processor, microprocessor, controller, or other signal processing device.

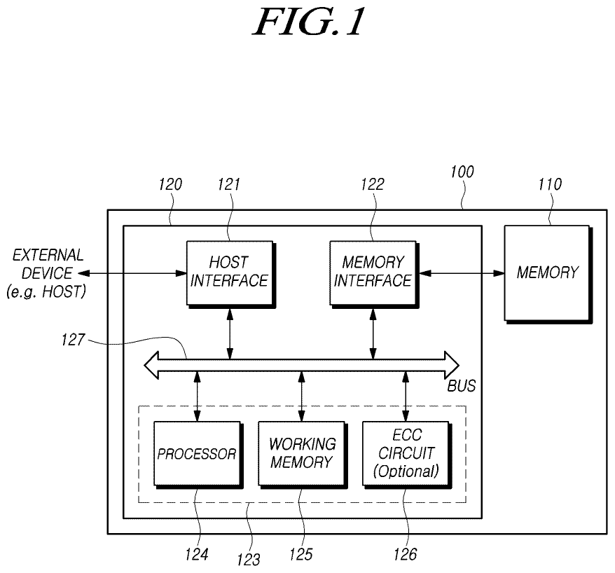

FIG. 1 is a schematic configuration diagram of a storage device 100 according to an embodiment of the disclosure.

Referring to FIG. 1, the storage device 100 may include a memory 110 that stores data and a controller 120 that is coupled to be in communication with, and controls, the memory 110.

The memory 110 includes a plurality of memory blocks, and operates in response to the control of the controller 120. Operations of the memory 110 may include, for example, a read operation, a program operation (also referred to as a write operation) and an erase operation in response to control signaling from the controller 120.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the disclosure may be applied to a charge trap flash (CTF) in which a charge storage layer is configured by a dielectric layer and a flash memory in which a charge storage layer is configured by a conductive floating gate.

The memory 110 may receive a command for an operation and an address associated with the operation from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 in communication with the memory 110 may control write (program), read, erase and background operations in the memory 110. For example, background operations may include at least a garbage collection (GC) operation, a wear leveling (WL) operation, a read reclaim (RR) operation, a bad block management (BBM) operation, and so forth.

The controller 120 may control the operation of the memory 110 based on a request from a device (e.g., a host) located outside the storage device 100. The controller 120, however, also may control the operation of the memory 110 regardless of, or in absence of, a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be in various configurations in implementations, e.g., they are separated from each other in some implementations, or the controller 120 and the host may be integrated into one device in other implementations. Hereunder, for the sake of convenience in explanation, the specific examples below will describe the controller 120 and the host as devices that are separated from each other.

Referring to FIG. 1, the controller 120 may include a memory interface 122 that interfaces with or is in communication with the memory device 110 and a control circuit 123, and may further include a host interface 121 that interfaces with or is in communication with the host device which may access the memory device 110 via the controller 120.

The host interface 121 provides an interface for communication with the host and may use various interface protocols, including, for example, a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol or a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 in response to the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting. Hereafter, an operation of the storage device 100 based on some embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include, for example, a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and/or a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 based on a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, one or more of an SRAM (static RAM), a DRAM (dynamic RAM) or an SDRAM (synchronous DRAM). Meanwhile, the controller 120 may additionally use a separate volatile memory (e.g., SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine, decide or deem that a corresponding sector is uncorrectable or a “fail.” On the other hand, when a bit error rate is lower than the reference value, the error detection and correction circuit 126 may determine, decide or deem that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined or deemed to be uncorrectable. The error detection and correction circuit 126 may transfer information (e.g., address information) regarding a sector which is determined or deemed to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

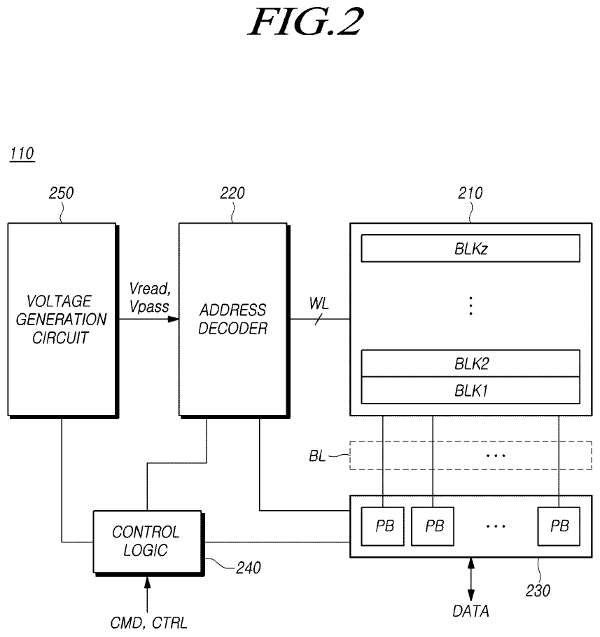

Hereinbelow, the memory 110 will be described in further detail with reference to FIG. 2.

FIG. 2 is a block diagram schematically illustrating a memory 110 of FIG. 1.

Referring to FIG. 2, the memory 110 according to an embodiment of the disclosure may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include, for example, a block address, a row address and/or a column address.

The address decoder 220 may select one memory block and one word line depending on a block address and a row address. A column address may be decoded by the address decoder 220 and be provided to the read and write circuit 230.

The address decoder 220 may include, for example, one or more of a block decoder, a row decoder, a column decoder and/or an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may hold or latch data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. As an exemplary embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

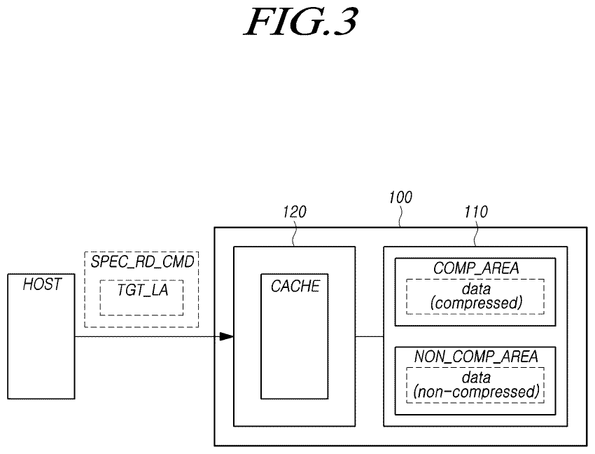

FIG. 3 is a diagram illustrating the schematic structure of a storage device 100 based on some embodiments of the disclosed technology.

Referring to FIG. 3, the storage device 100 may include a memory 110 and a controller 120.

The memory 110 may include a compression memory area COMP_AREA and a non-compression memory area NON_COMP_AREA. The compression memory area COMP_AREA is an area where data is stored in a compressed state, and the non-compression memory area NON_COMP_AREA is an area where data is stored in a non-compressed state (e.g., data is stored in its original size). In some embodiments, the term “compressed memory area” can be used to indicate the compression memory area COMP_AREA, and the term “uncompressed memory area” can be used to indicate the non-compression memory area NON_COMP_AREA.

When storing data in the compression memory area COMP_AREA, the size of the compressed data is reduced, thereby decreasing the storage capacity required for storing the data. However, when reading data stored in the compression memory area COMP_AREA, it is necessary to perform a decompression operation on the compressed data.

On the other hand, when storing data in the non-compression memory area NON_COMP_AREA, the storage capacity required for storing data does not decrease. However, since no decompression operation is required when reading data stored in the non-compression memory area NON_COMP_AREA, the stored data may be read more quickly.

The ratio of the compression memory area COMP_AREA and the non-compression memory area NON_COMP_AREA in the memory 110 may be set during the booting process of the storage device 100.

The controller 120 may receive a speculative memory read command SPEC_RD_CMD from a host HOST. In some implementations, a speculative memory read is a mechanism in which a processor predicts the likelihood of data being used.

The controller 120 may receive the speculative memory read command SPEC_RD_CMD from the host HOST using a predefined interface.

The speculative memory read command SPEC_RD_CMD may include a target logical address TGT_LA. The speculative memory read command SPEC_RD_CMD may indicate that the target data corresponding to the target logical address TGT_LA is likely to be read. Therefore, the controller 120 may speculatively determine that the target data may be read.

The host HOST may transmit the speculative memory read command SPEC_RD_CMD to the storage device 100 to reduce the latency between a post-processing operation (e.g., cache coherence management, data copy operation, etc.) after reading data and a subsequent data read operation.

The speculative memory read command SPEC_RD_CMD merely indicates that the target data corresponding to the target logical address TGT_LA is likely to be read, but it does not request that the target data be actually read.

Therefore, the host HOST does not require a response to the speculative memory read command SPEC_RD_CMD, and the controller 120 also does not transmit a response to the host HOST for the received speculative memory read command SPEC_RD_CMD.

After receiving the speculative memory read command SPEC_RD_CMD, the controller 120 may determine the area where the target data is stored. The area where the target data is stored may be the compression memory area COMP_AREA or the non-compression memory area NON_COMP_AREA described above.

The controller 120 may determine where the target data is stored, either in the compression memory area COMP_AREA or the non-compression memory area NON_COMP_AREA.

In some implementations, the controller 120 may determine where to store data in a cache CACHE based on where the data is stored, either in the compression memory area COMP_AREA or the non-compression memory area NON_COMP_AREA. In some implementations, the cache CACHE may be divided into an area for caching data stored in the compression memory area COMP_AREA and an area for caching data stored in the non-compression memory area NON_COMP_AREA. For example, the cache CACHE may include a first area and a second area, where data stored in the compression memory area COMP_AREA is cached in the first area, and data stored in the non-compression memory area NON_COMP_AREA is cached in the second area.

To this end, the cache CACHE may be implemented as physically separated sub caches. For example, the cache CACHE may include a first sub cache and a second sub cache. The first sub cache may cache data stored in the non-compression memory area NON_COMP_AREA, and the second sub cache may cache data stored in the compression memory area COMP_AREA.

The cache CACHE may store data read from the memory 110. FIG. 3 illustrates an example where the cache CACHE is located inside the controller 120, but the cache CACHE may be located outside the controller 120.

The cache CACHE may be implemented in various ways.

For example, the cache CACHE may be a working memory (see 125 of FIG. 1) included in the controller 120.

As another example, the cache CACHE may be a separate volatile memory located inside or outside the controller 120.

The storage device 100 and the memory 110 and the controller 120 included in the storage device 100 may be implemented in various ways.

For example, the storage device 100 may be implemented as a CXL (Compute eXpress Link) device, which supports a CXL interface. The storage device 100 may allow the host HOST to access the storage device 100 through a “CXL.mem” transaction of the CXL interface.

The controller 120 may be a CXL controller, which supports a CXL specification. The controller 120 may receive the aforementioned speculative memory read command SPEC_RD_CMD from the host HOST through the CXL interface. For example, the storage device 100 may include a plurality of memory devices 110 each composed of DRAM, and may be used as a memory expansion device for the host HOST.

Hereinbelow, an operation in which the storage device 100 searches for target data corresponding to the target logical address TGT_LA will be described.

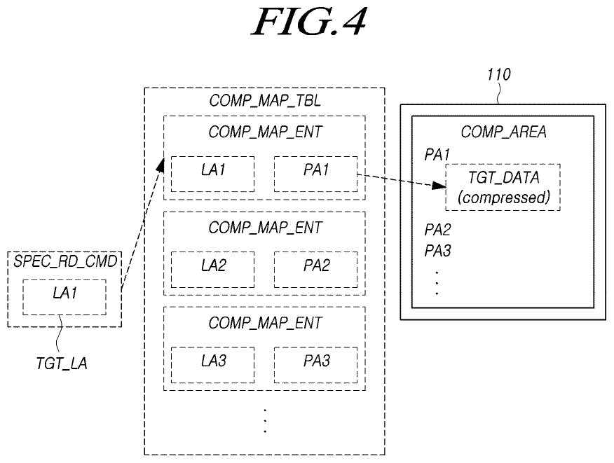

FIG. 4 is a diagram illustrating an operation in which the storage device 100 based on some embodiments of the disclosed technology searches for target data TGT_DATA stored in the compression memory area COMP_AREA using a compression map table COMP_MAP_TBL.

Referring to FIG. 4, the controller 120 of the storage device 100 may determine whether a compression map entry corresponding to the target logical address TGT_LA exists in a compression map table COMP_MAP_TBL including a plurality of compression map entries COMP_MAP_ENT.

The compression map table COMP_MAP_TBL may be stored in the memory 110. The controller 120 may load the compression map table COMP_MAP_TBL from the memory 110 and search for the compression map entry corresponding to the target logical address TGT_LA.

Each of the plurality of compression map entries COMP_MAP_ENT may indicate the mapping relationship between a logical address and a physical address in the compression memory area COMP_AREA.

In FIG. 4, the plurality of compression map entries COMP_MAP_ENT indicate that a logical address LA1 corresponds to a physical address PA1, a logical address LA2 corresponds to a physical address PA2, and a logical address LA3 corresponds to a physical address PA3.

In each compression map entry, the size of a unit area corresponding to a logical address is larger than or equal to the size of a unit area corresponding to a physical address, as data size is reduced during the data compression process.

For example, in a case where the size of a unit area corresponding to the logical address LA1 is 16 KB, the size of a unit area corresponding to the physical address PA1 may be 4 KB. This means that 16 KB of data corresponding to the logical address LA1 has been compressed into 4 KB and stored at the physical address PA1.

Each compression map entry may additionally include information indicating the size of compressed data.

In FIG. 4, the target logical address TGT_LA is the logical address LA1. Therefore, the controller 120 may search for a compression map entry corresponding to the logical address LA1 in the compression map table COMP_MAP_TBL.

The controller 120 may access the compression map entry corresponding to the logical address LA1 and obtain the physical address PA1, which is a physical address within the compression memory area COMP_AREA mapped to the logical address LA1.

In this way, the controller 120 may search for and locate target data TGT_DATA at the physical address PA1 within the compression memory area COMP_AREA. Since the target data TGT_DATA is stored in a compressed state, a decompression process is required to read the target data TGT_DATA.

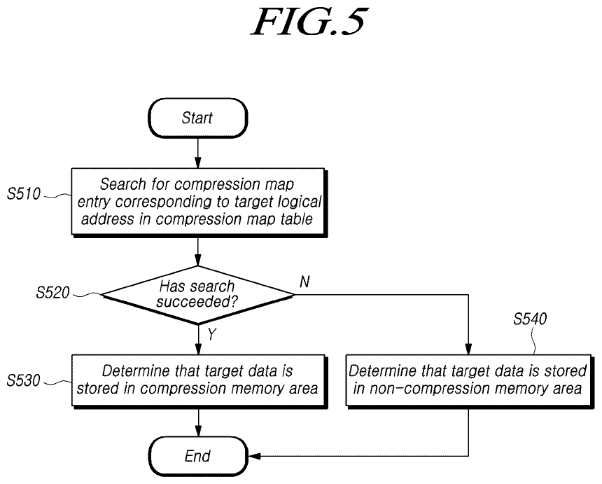

FIG. 5 is a flowchart illustrating an operation in which the storage device 100 based on some embodiments of the disclosed technology determines an area where the target data TGT_DATA is stored.

Referring to FIG. 5, the controller 120 of the storage device 100 searches for a compression map entry corresponding to the target logical address TGT_LA in the compression map table COMP_MAP_TBL described above with reference to FIG. 4 (S510).

The controller 120 determines whether the search for a compression map entry corresponding to the target logical address TGT_LA is successful (S520).

When the search for a compression map entry corresponding to the target logical address TGT_LA is successful (S520-Y), the controller 120 may determine that the target data TGT_DATA corresponding to the target logical address TGT_LA is stored in the compression memory area COMP_AREA (S530).

On the other hand, when the search for a compression map entry corresponding to the target logical address TGT_LA is not successful (S520-N), the controller 120 may determine that the target data TGT_DATA corresponding to the target logical address TGT_LA is stored in the non-compression memory area NON_COMP_AREA (S540).

The controller 120 may search for the target data TGT_DATA differently from the method described above with reference to FIG. 5.

For example, the controller 120 may first search the non-compression memory area NON_COMP_AREA to check whether the target data TGT_DATA corresponding to the target logical address TGT_LA is stored in the non-compression memory area NON_COMP_AREA, and when the target data TGT_DATA is not stored in the non-compression memory area NON_COMP_AREA, the controller 120 may search the compression memory area COMP_AREA to check whether the target data TGT_DATA is stored in the compression memory area COMP_AREA.

As another example, the controller 120 may simultaneously perform an operation of searching for the target data TGT_DATA in the non-compression memory area NON_COMP_AREA and an operation of searching for a compression map entry in the compression memory area COMP_AREA.

As another example, the controller 120 may determine which area to prioritize for searching, either the compression memory area COMP_AREA or the non-compression memory area NON_COMP_AREA, depending on a preconfigured compression ratio. For example, when the preconfigured compression ratio is equal to or greater than a threshold compression ratio, the controller 120 may first search for a compression map entry corresponding to the target logical address TGT_LA in the compression memory area COMP_AREA, and when the preconfigured compression ratio is less than the threshold compression ratio, the controller 120 may first search for the target data TGT_DATA in the non-compression memory area NON_COMP_AREA. On the other hand, the controller 120 may first search for a compression map entry corresponding to the target logical address TGT_LA in the compression memory area COMP_AREA when the preconfigured compression ratio is less than the threshold compression ratio, and may first search for the target data TGT_DATA in the non-compression memory area NON_COMP_AREA when the preconfigured compression ratio is equal to or greater than the threshold compression ratio.

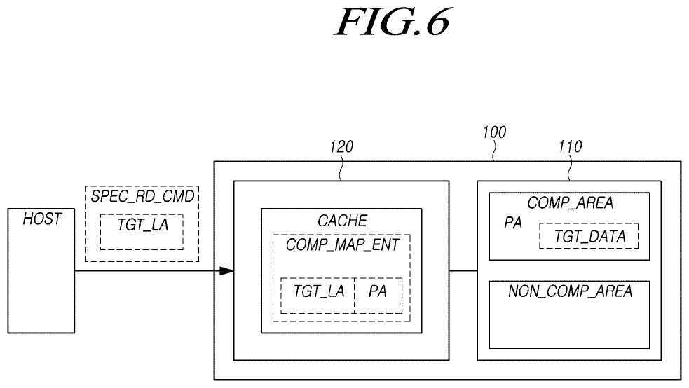

FIG. 6 is a diagram illustrating an operation in which the storage device 100 based on some embodiments of the disclosed technology stores a compression map entry COMP_MAP_ENT corresponding to the target logical address TGT_LA in the cache CACHE.

Referring to FIG. 6, when the search for the compression map entry COMP_MAP_ENT corresponding to the target logical address TGT_LA is successful, the controller 120 of the storage device 100 may store the compression map entry COMP_MAP_ENT corresponding to the target logical address TGT_LA in the cache CACHE.

The compression map entry COMP_MAP_ENT corresponding to the target logical address TGT_LA indicates that the target logical address TGT_LA is mapped to a physical address PA. The physical address PA indicates a location where the target data TGT_DATA is stored in the compression memory area COMP_AREA.

In some implementations, the reason for storing the compression map entry COMP_MAP_ENT corresponding to the target logical address TGT_LA in the cache CACHE is to read the target data TGT_DATA more quickly when the host HOST subsequently requests to read the target data TGT_DATA. When the compression map entry COMP_MAP_ENT corresponding to the target logical address TGT_LA is stored in the cache CACHE, the controller 120 may access the cache CACHE instead of the memory 110 to quickly locate where the target data TGT_DATA is stored in the compression memory area COMP_AREA.

In some embodiments, as will be discussed below, the storage device 100 may determine whether to store the target data TGT_DATA in the cache CACHE based on the area where the target data TGT_DATA is stored.

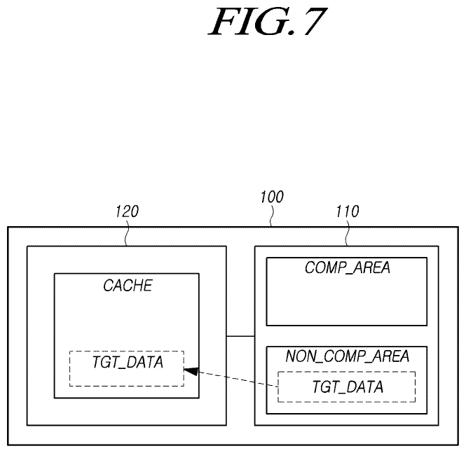

FIG. 7 is a diagram illustrating an example of an operation in which the storage device 100 based on some embodiments of the disclosed technology determines whether to store the target data TGT_DATA in the cache CACHE.

Referring to FIG. 7, the controller 120 of the storage device 100 may store the target data TGT_DATA in the cache CACHE when it is determined that the target data TGT_DATA is stored in the non-compression memory area NON_COMP_AREA.

The controller 120 may store the target data TGT_DATA stored in the non-compression memory area NON_COMP_AREA directly in the cache CACHE without performing a separate decompression operation.

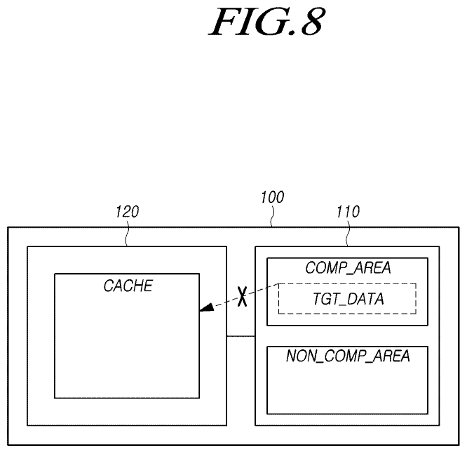

FIG. 8 is a diagram illustrating another example of the operation in which the storage device 100 based on some embodiments of the disclosed technology determines whether to store the target data TGT_DATA in the cache CACHE.

Referring to FIG. 8, the controller 120 of the storage device 100 may not store the target data TGT_DATA in the cache CACHE when it is determined that the target data TGT_DATA is stored in the compression memory area COMP_AREA.

To store the target data TGT_DATA located in the compression memory area COMP_AREA in the cache CACHE, a decompression operation is performed on the stored target data TGT_DATA. When the controller 120 uses resources to store the target data TGT_DATA in the cache CACHE before the host HOST requests to read it, there is a risk that the resources needed for ongoing read operations may become insufficient, potentially leading to degraded read performance.

In addition, when storing the target data TGT_DATA in the cache CACHE, existing data previously stored in the cache CACHE may be evicted to create space for the target data TGT_DATA. As a result, data being used for ongoing read operations may be evicted from the cache CACHE, resulting in a decrease in the cache hit rate.

For example, when the target data TGT_DATA of 64 bytes is stored in the compression memory area COMP_AREA, an operation of decompressing a 4 KB data chunk including the target data TGT_DATA may be required. In this case, if the result of decompressing the data chunk is stored in the cache CACHE, the previously stored 4 KB of data in the cache CACHE may be evicted.

In this case, the 64-byte target data TGT_DATA, whose further access is uncertain, causes 4 KB of data to be evicted from the cache CACHE. If the evicted data is later accessed again, additional resources are used to read the evicted data, potentially leading to performance deterioration.

To address this issue, when it is determined that the target data TGT_DATA is stored in the compression memory area COMP_AREA, the storage device 100 may determine whether to store the target data TGT_DATA in the cache CACHE, based on the compressed size of the target data TGT_DATA.

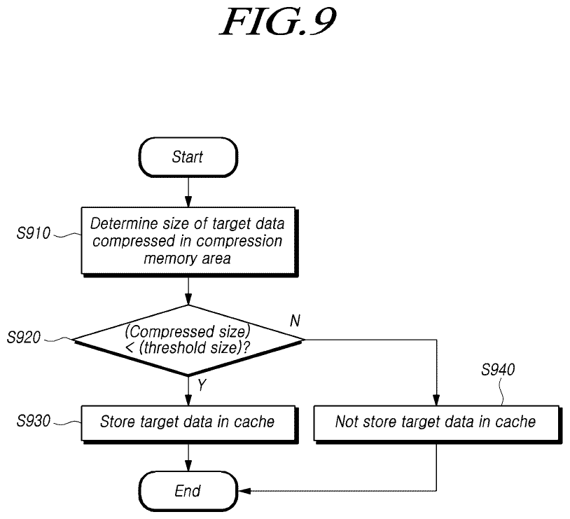

FIG. 9 is a flowchart illustrating an operation in which the storage device 100 based on some embodiments of the disclosed technology determines whether to store the target data TGT_DATA in the cache CACHE, based on the compressed size of the target data TGT_DATA.

Referring to FIG. 9, the controller 120 of the storage device 100 may determine the compressed size of the target data TGT_DATA in the compression memory area COMP_AREA (S910). For example, the controller 120 may determine the compressed size of the target data TGT_DATA based on the information included in the compression map entry COMP_MAP_ENT corresponding to the target logical address TGT_LA.

For example, the controller 120 determines whether the compressed size of the target data TGT_DATA is smaller than a preset threshold size (S920).

When the compressed size of the target data TGT_DATA is smaller than the threshold size (S920-Y), the controller 120 may store the target data TGT_DATA in the cache CACHE (S930).

On the other hand, when the compressed size of the target data TGT_DATA is equal to or larger than the threshold size (S920-N), the controller 120 may not store the target data TGT_DATA in the cache CACHE (S940).

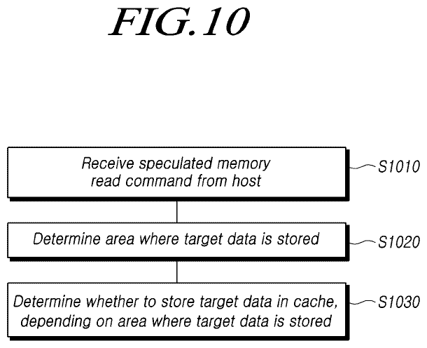

FIG. 10 is a diagram illustrating a method for operating a storage device 100 based on some embodiments of the disclosed technology.

Referring to FIG. 10, the method for operating the storage device 100 may include operation S1010 to receive, from a host HOST, a speculative memory read command SPEC_RD_CMD indicating a possibility that target data TGT_DATA corresponding to a target logical address TGT_LA is to be read.

The method for operating the storage device 100 may include operation S1020 to search for or locate an area where the target data TGT_DATA is stored in a memory 110 including a compression memory area COMP_AREA where data is stored in a compressed state and a non-compression memory area NON_COMP_AREA where data is stored in a non-compressed state (e.g., data is stored in its original size).

The operation S1020 may also include searching for and locating a compression map entry corresponding to the target logical address TGT_LA in a compression map table COMP_MAP_TBL including a plurality of compression map entries COMP_MAP_ENT. Each of the plurality of compression map entries COMP_MAP_ENT may indicate the mapping relationship between a logical address and a physical address in the compression memory area COMP_AREA.

For example, the operation S1020 may include determining that the target data TGT_DATA is stored in the compression memory area COMP_AREA when the search for the compression map entry corresponding to the target logical address TGT_LA in the compression map table COMP_MAP_TBL succeeds, and may determine that the target data TGT_DATA is stored in the non-compression memory area NON_COMP_AREA when the search for the compression map entry corresponding to the target logical address TGT_LA in the compression map table COMP_MAP_TBL fails (e.g., when there is no compression map entry corresponding to the target logical address TGT_LA in the compression map table COMP_MAP_TBL).

The method for operating the storage device 100 may include operation S1030 to determine whether to store the target data TGT_DATA in a cache CACHE configured to temporarily store data read from the memory 110, based on where the target data TGT_DATA is stored, either in the compression memory area COMP_AREA or the non-compression memory area NON_COMP_AREA.

The method for operating the storage device 100 may further include storing the compression map entry corresponding to the target logical address TGT_LA in the cache CACHE when the search for the compression map entry corresponding to the target logical address TGT_LA in the operation S1020 has succeeded.

The method for operating the storage device 100 may further include storing the target data TGT_DATA in the cache CACHE when it is determined that the target data TGT_DATA is stored in the non-compression memory area NON_COMP_AREA.

The storage device 100 may not store the target data TGT_DATA in the cache CACHE when it is determined that the target data TGT_DATA is stored in the compression memory area COMP_AREA.

In some implementations, the method for operating the storage device 100 may further include determining whether to store the target data TGT_DATA in the cache CACHE, based on the size of the target data TGT_DATA compressed in the compression memory area COMP_AREA, when it is determined that the target data TGT_DATA is stored in the compression memory area COMP_AREA.

In some implementations, determining whether to store the target data TGT_DATA in the cache CACHE based on the compressed size of the target data TGT_DATA, may include determining to store the target data TGT_DATA in the cache CACHE when the compressed size of the target data TGT_DATA is smaller than a threshold size, and determining to not store the target data TGT_DATA in the cache CACHE when the compressed size of the target data TGT_DATA is equal to or larger than the threshold size.

Only a few embodiments and examples are described. Enhancements and variations of the disclosed embodiments and other embodiments can be made based on what is described and illustrated in this patent document.

What is claimed is:

1. A data storage device comprising:
a memory device including: a compression memory area configured to store data in a compressed state; and a non-compression memory area configured to store data in a non-compressed state; and
a controller in communication with the memory device to control the memory device and configured to: receive, from a host, a speculative memory read command indicating a possibility that target data corresponding to a target logical address in the memory device is to be read; determine, in response to receiving the speculative memory read command, where the target data is stored in the memory device, either in the compression memory area or the non-compression memory area; and
determine whether to store, in a cache, the target data from the memory device, based on where the target data is stored in the memory device, either in the compression memory area or the non-compression memory area.

2. The data storage device according to claim 1, wherein
the controller is configured to determine whether a compression map entry corresponding to the target logical address exists in a compression map table including a plurality of compression map entries, and
wherein each of the plurality of compression map entries indicates a mapping relationship between a logical address and a physical address in the compression memory area.

3. The data storage device according to claim 2, wherein the controller is configured to:
determine that the target data is stored in the compression memory area upon successfully searching for a compression map entry corresponding to the target logical address in the compression map table; and
determine that the target data is stored in the non-compression memory area upon failing to search for the compression map entry corresponding to the target logical address in the compression map table.

4. The data storage device according to claim 2, wherein, upon determination of that a compression map entry corresponding to the target logical address exists, the controller stores the compression map entry corresponding to the target logical address in the cache.

5. The data storage device according to claim 1, wherein the controller stores the target data in the cache when it is determined that the target data is stored in the non-compression memory area.

6. The data storage device according to claim 5,
wherein the cache comprises a first sub-cache configured to temporarily store data from the non-compression memory area and a second sub-cache configured to temporarily store data from the compression memory area, and
wherein the controller stores the target data in the first sub-cache.

7. The data storage device according to claim 4, wherein, upon determination of that the target data is stored in the compression memory area, the controller stores the target data in the cache using the compression map entry corresponding to the target logical address stored in the cache, in response to a read command for the target data received from the host.

8. The data storage device according to claim 7,
wherein the cache comprises a first sub cache which caches data stored in the non-compression memory area and a second sub cache which caches data stored in the compression memory area, and
wherein the controller stores the target data in the second sub cache.

9. The data storage device according to claim 1, wherein, upon determination of that the target data is stored in the compression memory area, the controller determines whether to store the target data in the cache based on a size of the target data compressed in the compression memory area.

10. The data storage device according to claim 9, wherein the controller is configured to:
store the target data in the cache upon determination of that a compressed size of the target data is smaller than a threshold size; and
avoid storing the target data in the cache upon determination of that the compressed size of the target data is equal to or larger than the threshold size.

11. A method for operating a data storage device, comprising:
receiving, from a host, a speculative memory read command indicating that a possibility that target data corresponding to a target logical address is to be read;
determining where the target data is stored in a memory device including a compression memory area where data is stored in a compressed state and a non-compression memory area where data is stored in a non-compressed state; and
determining whether to store the target data in a cache configured store data read from the memory device, based on where the target data is stored in the memory device, either in the compression memory area or the non-compression memory area.

12. The method according to claim 11,
wherein the determining where the target data is stored in the memory device comprises determining whether a compression map entry corresponding to the target logical address exists in a compression map table including a plurality of compression map entries, and
wherein each of the plurality of compression map entries indicates a mapping relationship between a logical address and a physical address in the compression memory area.

13. The method according to claim 12, wherein the determining where the target data is stored in the memory device comprises:
determining that the target data is stored in the compression memory area upon successfully searching for a compression map entry corresponding to the target logical address in the compression map table; and
determining that the target data is stored in the non-compression memory area upon failing to search for the compression map entry corresponding to the target logical address in the compression map table.

14. The method according to claim 12, further comprising:
storing, upon determination of that a compression map entry corresponding to the target logical address exists, the compression map entry corresponding to the target logical address in the cache.

15. The method according to claim 11, further comprising:
storing the target data in the cache upon determination of that the target data is stored in the non-compression memory area.

16. A Compute eXpress Link (CXL) device comprising:
a memory device including a compression memory area where data is stored in a compressed state and a non-compression memory area where data is stored in a non-compressed state; and
a CXL controller in communication with the memory device and configured to: receive, through a CXL interface from a host, a speculative memory read command indicating that a possibility that target data corresponding to a target logical address is to be read; determine, in response to receiving the speculative memory read command, where the target data is stored in the memory device, either in the compression memory area or the non-compression memory area; and determine whether to store the target data in a cache configured to store data read from the memory, based on where the target data is stored in the memory device, either in the compression memory area or the non-compression memory area.

17. The CXL device according to claim 16, wherein
the CXL controller determines whether a compression map entry corresponding to the target logical address exists in a compression map table including a plurality of compression map entries, and
each of the plurality of compression map entries indicates a mapping relationship between a logical address and a physical address in the compression memory area.

18. The CXL device according to claim 17, wherein the CXL controller is configured to:
determine that the target data is stored in the compression memory area upon successfully searching for a compression map entry corresponding to the target logical address in the compression map table, and
determine that the target data is stored in the non-compression memory area upon failing to search for the compression map entry corresponding to the target logical address in the compression map table.

19. The CXL device according to claim 17, wherein, upon determination of that a compression map entry corresponding to the target logical address exists, the CXL controller stores the compression map entry corresponding to the target logical address in the cache.

20. The CXL device according to claim 16, wherein the CXL controller stores the target data in the cache upon determination of that the target data is stored in the non-compression memory area.
